(19) United States
(12) Patent Application Publication
(10) Pub. No.: US 2010/0319549 A1
(43) Pub. Date: Dec. 23, 2010

(54) BREWING ACCESSORY

(76) Inventors: Charles F. Kelty, Santa Fe, NM (US); Jessica Rae Benton Kelty, Santa Fe, NM (US)

Correspondence Address: PEACOCK MYERS, P.C., 201 THIRD STREET, N.W., SUITE 1340, ALBUQUERQUE, NM, 87102, US

(21) Appl. No.: 12/821,040

(22) Filed: Jun. 22, 2010

Related U.S. Application Data
(60) Provisional application No. 61/219,189, filed on Jun. 22, 2009.

(51) Int. Cl. A47J 31/00

(52) U.S. Cl. 99/297

(57) ABSTRACT

A method and apparatus for collecting spent solids from a brewing apparatus such as a French press coffee maker. An insert optionally holds predetermined measures of solids such as coffee or tea prior to brewing and collects the spent solids as they are separated from the liquid by the straining device of the apparatus. The insert connects to the straining device and is thus easily removable from the apparatus. The insert may be flexible in order to facilitate disposal of the spent solids.

### CROSS-REFERENCE TO RELATED APPLICATIONS

This application claims priority to and the benefit of the filing of U.S. Provisional Patent Application Ser. No. 61/219,189, entitled “Coffee Maker Accessory”, filed on Jun. 22, 2009, and the specification thereof is incorporated herein by reference.

### BACKGROUND OF THE INVENTION

1. Field of the Invention (Technical Field)

The present invention relates to methods and apparatuses improving and simplifying the usage and maintenance of beverage brewing devices, for example French press coffee makers.

2. Description of Related Art

French press coffee makers are often considered the best and easiest devices for creating inexpensive yet robust cups of coffee with superior taste as compared to other methods of brewing or making coffee. For all of its benefits, however, a French press can be messy and difficult to properly clean. Because of the nature of coffee grounds and limitation of modern plumbing systems, the used grounds should not be flushed down sinks, toilets or other plumbing fixtures. This necessitates the removal of the grounds from the French press by application of mechanical means such as a hand, towel or spatula for their deposition into a suitable location such as a waste receptacle. The cleaning process is further complicated by the fact that most French press coffee makers are constructed of glass and are often broken as a result of the difficulties in cleaning them. The removal process can be dangerous, messy, odorous and frustrating to the point that it actually discourages use of the French press coffee maker.

### BRIEF SUMMARY OF THE INVENTION

An embodiment of the present invention comprises a removable insert for a brewing apparatus comprising a plunger assembly, the insert comprising one or more compartments for holding solids and one or more attachment devices for removeably attaching the insert to the plunger assembly, wherein the insert is sized to slide within the apparatus. The insert is preferably comprised of a flexible material, preferably comprising silicone rubber. The flexible insert is preferably invertible for emptying the solids from the compartments. The insert of claim 1 preferably further comprises one or more openings between a front surface of the insert and a rear surface of the insert, wherein each opening preferably comprises a valve structure which is sufficiently closed during brewing to prevent solids from entering the opening. The valve structure preferably opens sufficiently during removal of the insert from the apparatus to prevent a vacuum forming between the insert and the apparatus. The valve structure preferably comprises a plurality of flexible flaps. The insert is preferably designed so that its rear surface does not rest flat against a bottom of the apparatus. The brewing apparatus preferably comprises a French press coffee maker. The attachment devices are preferably selected from the group consisting of magnets, magnetic bodies, magnetic fasteners, or mechanical clips. The one or more compartments are preferably sized to hold an amount of solids measured to produce a desired quantity of beverage. The insert of claim 1 preferably further comprises a squeegee blade disposed around a circumference of the insert. The insert preferably further comprises a protrusion for grabbing the insert, wherein the protrusion is preferably located inside a circumference of the insert. The insert preferably comprises a solid bottom.

Another embodiment of the present invention is a method for brewing a beverage from solids, the method comprising the steps of: disposing solids in one or more compartments in an insert; inserting the insert in a brewing apparatus; brewing the beverage; straining solids from the beverage into the one or more; attaching the insert to a plunger assembly; withdrawing the plunger assembly from the apparatus; removing the insert; and emptying the solids from the one or more compartments. The removing step preferably comprises grabbing a protrusion on the insert, wherein the protrusion is preferably located inside a circumference of the insert. The disposing step preferably comprises measuring a desired amount of solids. The attaching step preferably occurs automatically when the filter contacts the insert. The insert preferably comprises a flexible material, preferably comprising silicone rubber. The emptying step preferably comprises inverting the flexible insert. The apparatus preferably comprises a French press coffee maker. The method preferably further comprises the step of opening holes in the insert sufficiently to prevent a vacuum forming between the insert and the apparatus during the removing step.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 illustrates a perspective view of an embodiment of an insert of the present invention;

FIG. 2 illustrates a side cross-section view of the insert of FIG. 1;

FIG. 3 illustrates a top view of the insert of FIG. 1;

FIG. 4 illustrates the insert of FIG. 1 prior to insertion into a coffee maker carafe;

FIG. 5 illustrates a lid and plunger prior to insertion into the coffee maker carafe;

FIG. 6 illustrates the lid and plunger partly inserted into the coffee maker carafe;

FIG. 7 illustrates the lid and plunger fully inserted into the coffee maker carafe and seated on the insert of FIG. 1;

FIG. 8 illustrates the plunger, attached to the insert of FIG. 1, partly extracted from the coffee maker carafe;

FIG. 9 illustrates the plunger, attached to the insert of FIG. 1, fully extracted from the carafe;

FIG. 10 illustrates the plunger attached to the insert of FIG. 1 and separated from the coffee maker lid;

FIG. 11 illustrates the insert of FIG. 1 with a magnetic fastener;

FIG. 12 illustrates an alternative embodiment of an insert with a clip fastener;

FIG. 13 illustrates inverting a flexible version of the insert of FIG. 1;

FIG. 14 is a side perspective view of an alternative embodiment of an insert of the present invention;

FIG. 15 is a bottom perspective view of the insert of FIG. 14;

FIG. 16 is a top view of the insert of FIG. 14;

FIG. 17 is a side view of the insert of FIG. 14; and

FIG. 18 is a side cross-sectional view of the insert of FIG. 14.

### DETAILED DESCRIPTION OF THE INVENTION

A French press coffee maker or cafetière is typically constructed of a carafe or vessel with a handle and/or stabilizing structure, a lid with accommodation for pouring liquid out of the carafe without removing the lid and a penetration in the lid to allow for the actuation of a plunger assembly, which typically comprises a rod with a handle on one end and accommodation for attaching a straining apparatus on the other. The straining apparatus typically comprises a fine mesh screen for separating coffee grounds, tea leaves, or herbs from the water in the carafe and a structural frame to support the mesh as it is forcibly pressed into the carafe. Embodiments of the present invention solve cleaning issues and also preferably provide an integrated means for accurate proportioning of the coffee prior to the brewing process.

Although the embodiments and methods described herein generally describe making coffee, the invention is not limited to a coffee press or making coffee. The present invention is also useful for making herbal tea and any other brews, infusions, concoctions or solutions by steeping, brewing, soaking or dissolving. The descriptions herein for coffee are also applicable to these other brews, infusions, concoctions and solutions. As used throughout the specifications and claims, the term “solids” means coffee, coffee grounds, tea leaves, leaves, herbs, flowers, or any other material used to make a brewed beverage. Similarly, the present invention may be used with beverage makers other than French press coffee makers.

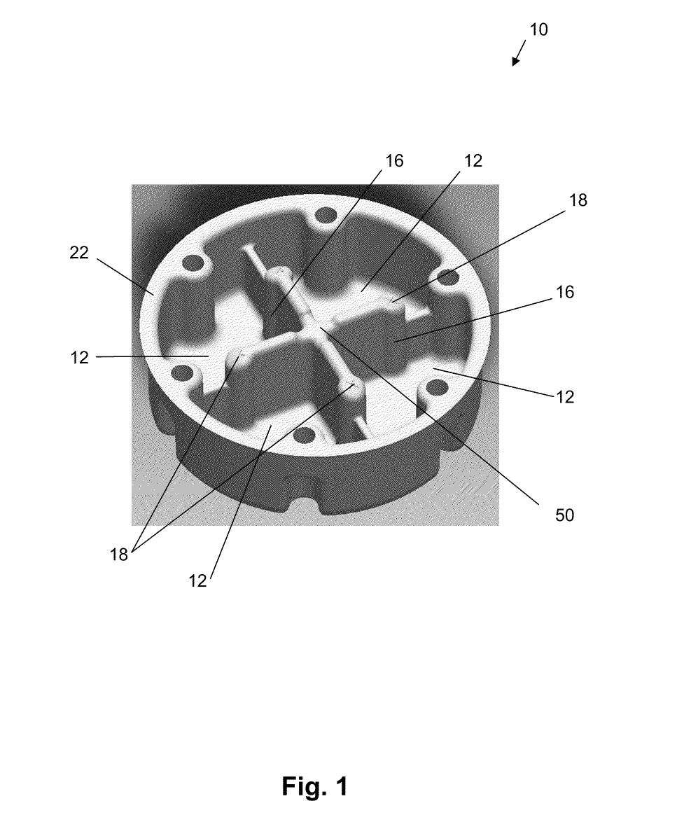

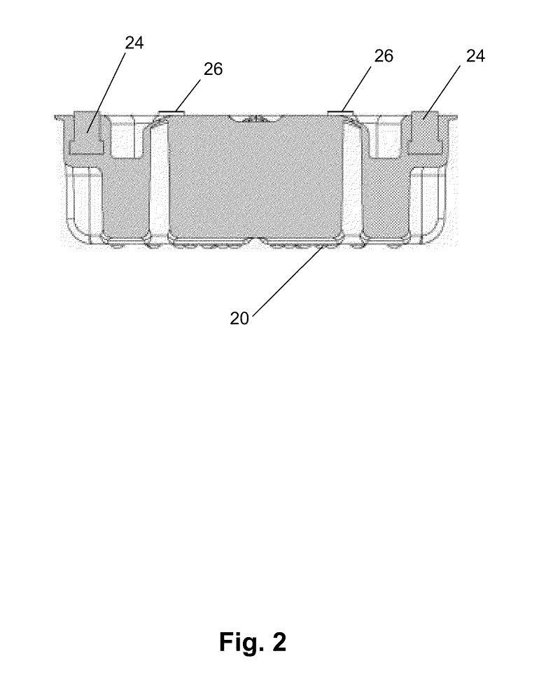

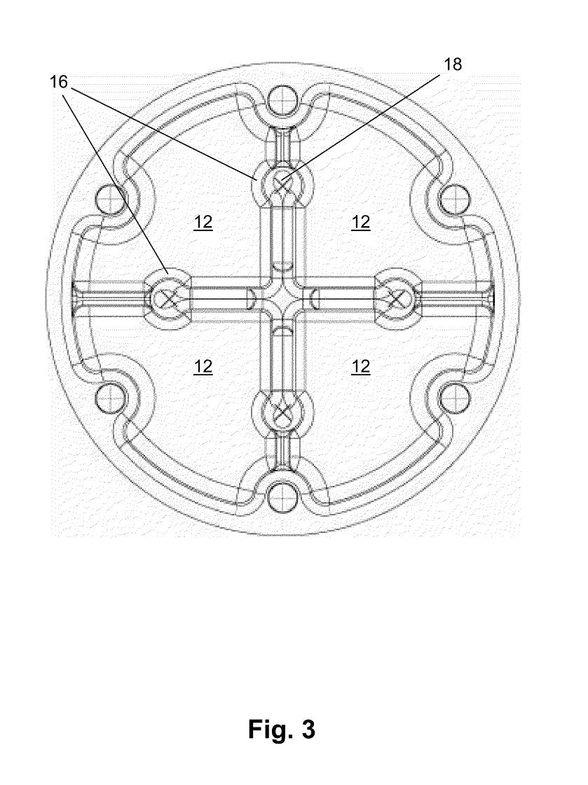

FIG. 1 illustrates a front perspective view of an embodiment of the present invention that provides a simple to use and easily installed modification to the common French press coffee maker in the form of an insert 10 that is inserted into a carafe and rests on the bottom of the carafe prior to application of hot water. FIG. 2 illustrates a side view of insert 10 and FIG. 3 illustrates a top view of insert 10. Insert 10 may comprise any material, including but not limited to plastic, rubber, silicone rubber, metal, ceramic, and glass. Insert 10 preferably comprises a diameter and outside size dimension resulting in a close interface with the inside diameter dimension of a French press carafe so that insert 10 may be inserted into or removed from the carafe with substantially no binding or substantive gaps at the interface. Insert 10 optionally comprises wiper blade or squeegee 22 around its outer top perimeter, thereby forming a snug but slideable seal against the inside of the carafe, in order to substantially fully remove all solids from the carafe as the insert is removed. Embodiments of the present invention may be used as a universal retrofit accessory for most French Press coffee makers, since most use the same diameter carafe.

Insert 10 preferably comprises one or more segmented chambers 12 within that are preferably proportioned relative to a desired quantity of solids in relation to the volume of water to be added to the carafe. Chambers 12 preferably correspond to a serving size (e.g. one chamber for one or two cups of coffee, etc.). These chambers also preferably collect the spent solids as they settle from suspension or are strained out after the application of water or other liquid and after steeping or brewing for a desired time. In addition to dividing insert 10 into chambers 12, partition structure 50 optionally may be used as a handle to facilitate manipulation of insert 10.

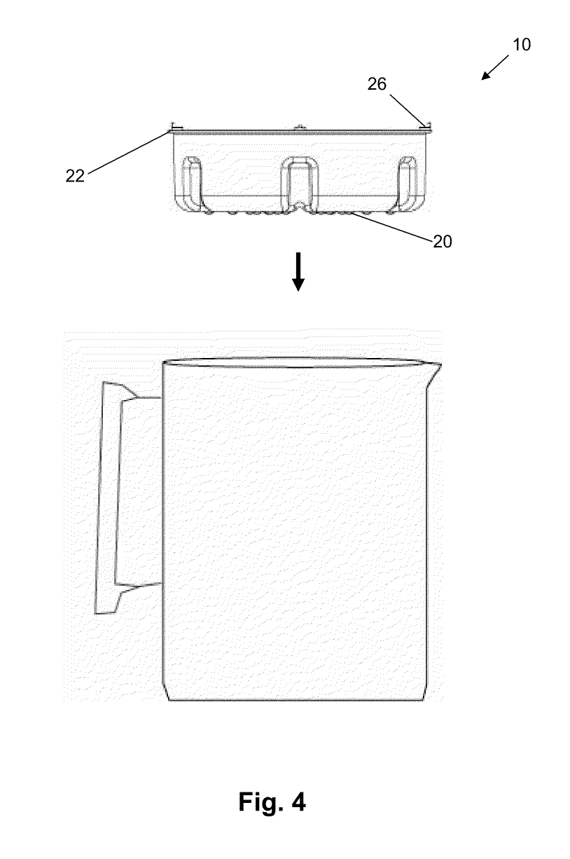

FIG. 4 illustrates insert 10 prior to insertion into a carafe. The insert is preferably positioned with chambers 12 positioned in an upward-facing direction prior to insertion into the carafe. The arrow indicates the insertion direction. At this stage, chamber(s) 12 are preferably at least partially filled with the coffee or desired substance. Chambers 12 may optionally be configured so that filling one chamber produces one cup of coffee, filling two chambers produces two cups of coffee, etc.

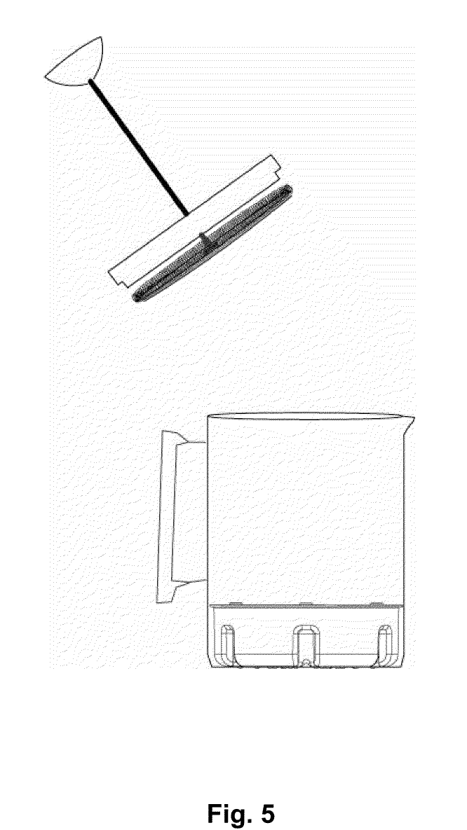

FIG. 5 illustrates insert 10 inserted fully into the carafe. The French press lid and plunger are depicted prior to insertion into the carafe. At this stage, water or other desired liquid is preferably added to the carafe.

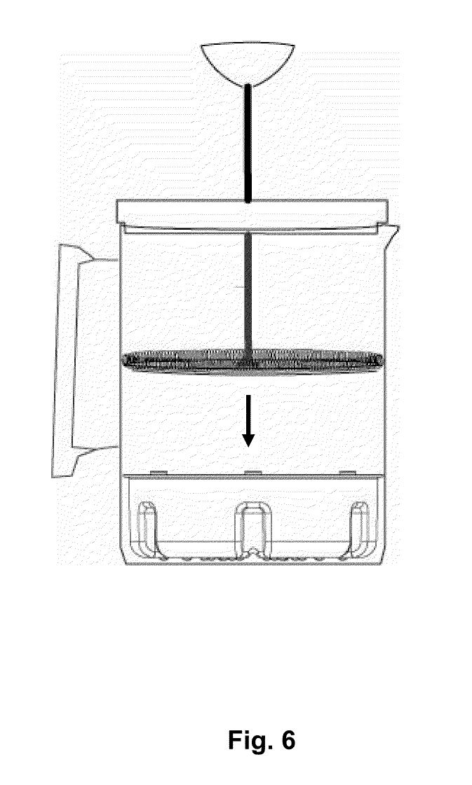

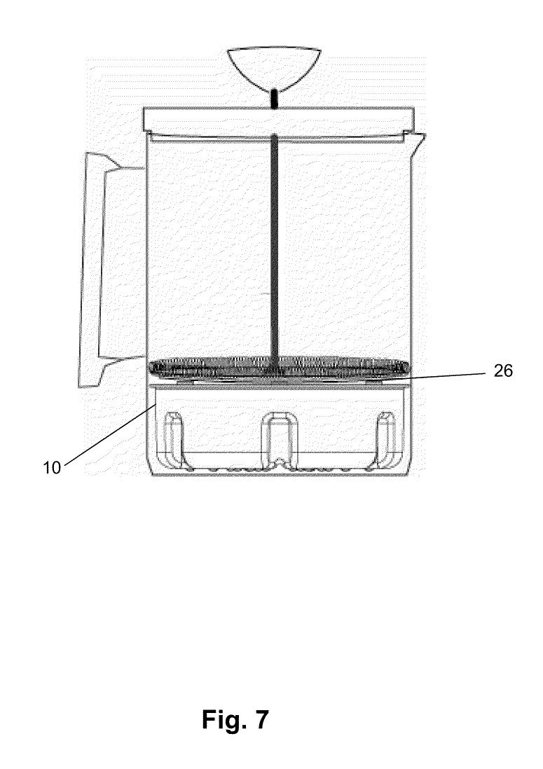

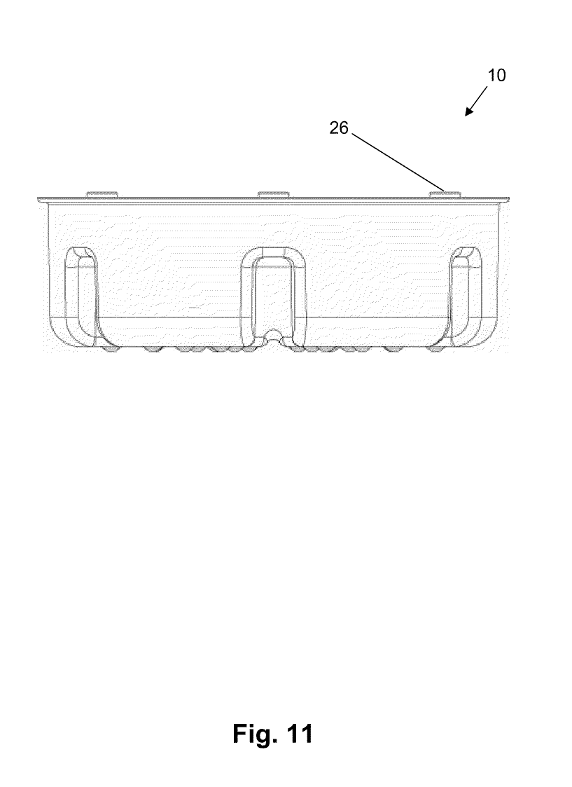

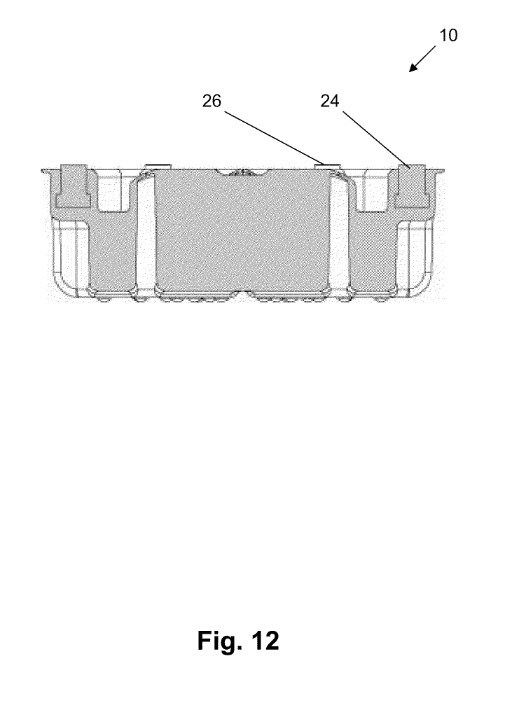

After the lid and plunger are installed on the carafe, and before, during, or after the desired steeping or brewing time period has elapsed, the plunger is pushed deeper in the carafe as shown in FIG. 6. The arrow indicates the direction of travel. As the French press strainer is plunged into the carafe, it strains and collects the spent solids and eventually pushes them into chambers 12 of insert 10. As shown in FIGS. 2, 4, 11, and 12, insert 10 preferably comprises one or more fastening devices such as mechanical clips 24 and/or magnets or magnetic fasteners 26 for automatically attaching insert 10 to the lower perforated straining plate the French press once the plunger has been fully inserted into the carafe, as shown in FIG. 7. Although the figures depict magnets and/or clips, any fastener may be used which preferably has one or more of the following features: a) is capable of attaching the insert to the plunger upon contact; b) allows the attached plunger/insert to be withdrawn from the carafe; and c) provides for separation of the insert and plunger after removal from the carafe. Insert 10 preferably comprises a height that does not interfere with the plunging action of the straining device when the French press coffee maker is operated.

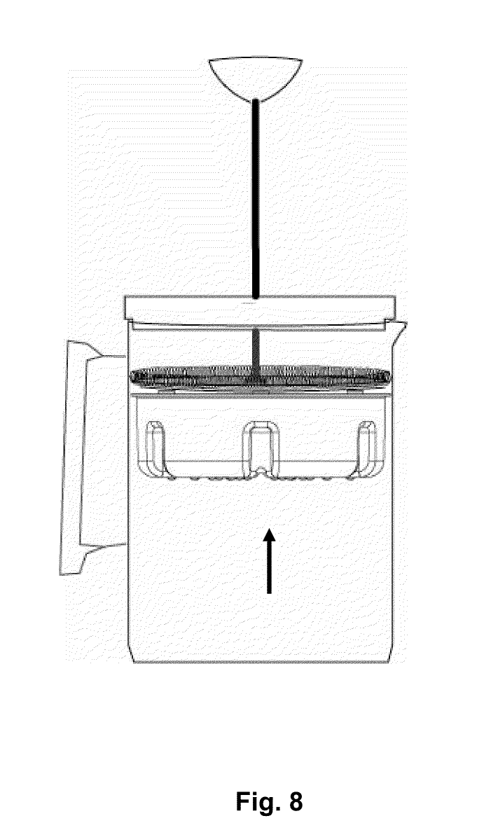

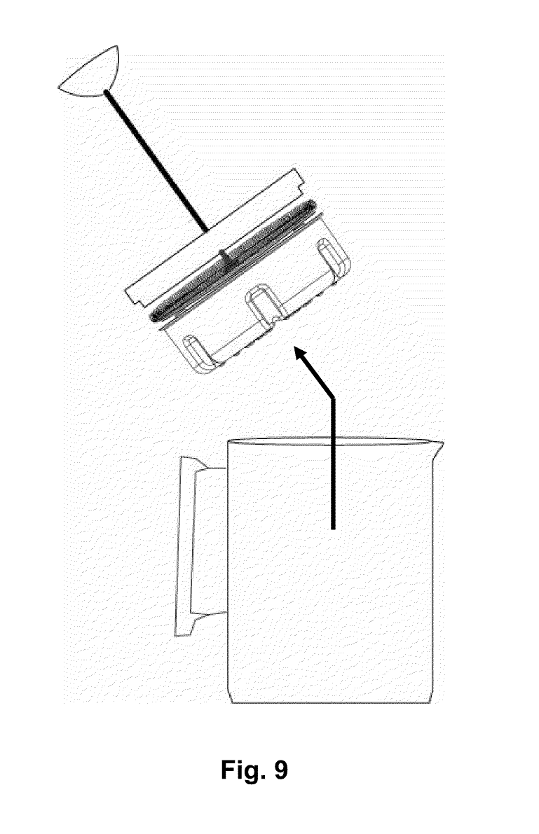

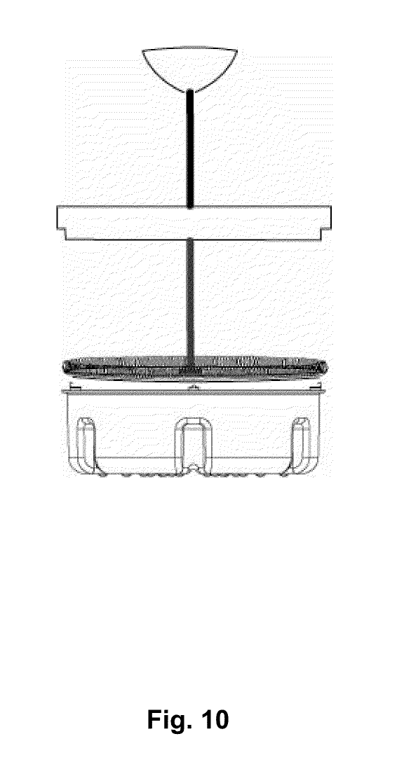

Once attached to the strainer, and after the desired brewing, steeping or soaking time, insert 10 (together with the solids contained in chambers 12) are preferably removed from the carafe along with the plunger as it is withdrawn, as shown in FIGS. 8-10, leaving the brewed coffee or other solution in the carafe. Insert 10 preferably comprises one or more vents or ports 16 disposed in insert 10 to prevent a vacuum from developing between the insert and the carafe as the insert is removed from the carafe. Valve structure 18 disposed in port 16 preferably comprises one or more openings small enough to prevent the solids from settling into the ports, while being large enough to prevent formation of a vacuum during insert removal. For example, for an insert comprising a flexible material, valve structure 18 may comprise a plurality of flaps which remain substantially closed during brewing, but are forced apart from each another by the difference in pressure when the insert is removed from the carafe. In addition, insert 10 optionally comprises a textured bottom 20, for example comprising a plurality of protrusions, so the flat bottom of insert 10 doesn't rest directly on the flat bottom of the carafe, thus helping to prevent vacuum formation as the insert is removed from the carafe.

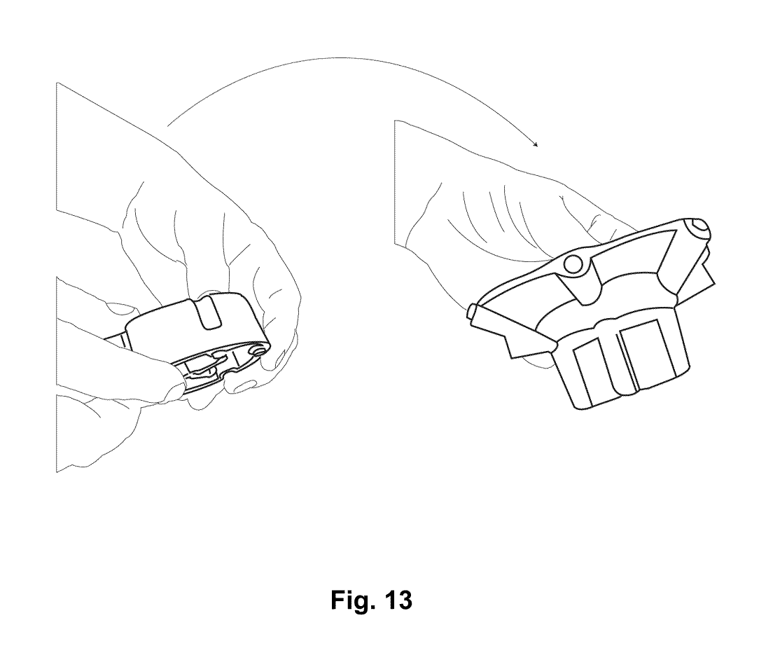

Upon complete removal from the carafe, the insert (containing the solids) is preferably separated from the strainer, emptied and cleaned for reuse. Integrated clips 24 and/or magnets 26 preferably provide easy single-action release, thereby allowing for easy disposal of the spent solids in a suitable waste receptacle or other desired location. The insert may be comprised of a flexible material such as rubber, silicone rubber, or plastic, in which case the insert may be inverted (i.e. turned inside out) for easy removal of the spent solids, as shown in FIG. 13. Partition structure 50 is optionally designed with slots or other features to facilitate inversion of insert 10. The insert preferably comprises a solid bottom, which prevents dripping or leaking of water or the beverage out of the insert prior to emptying.

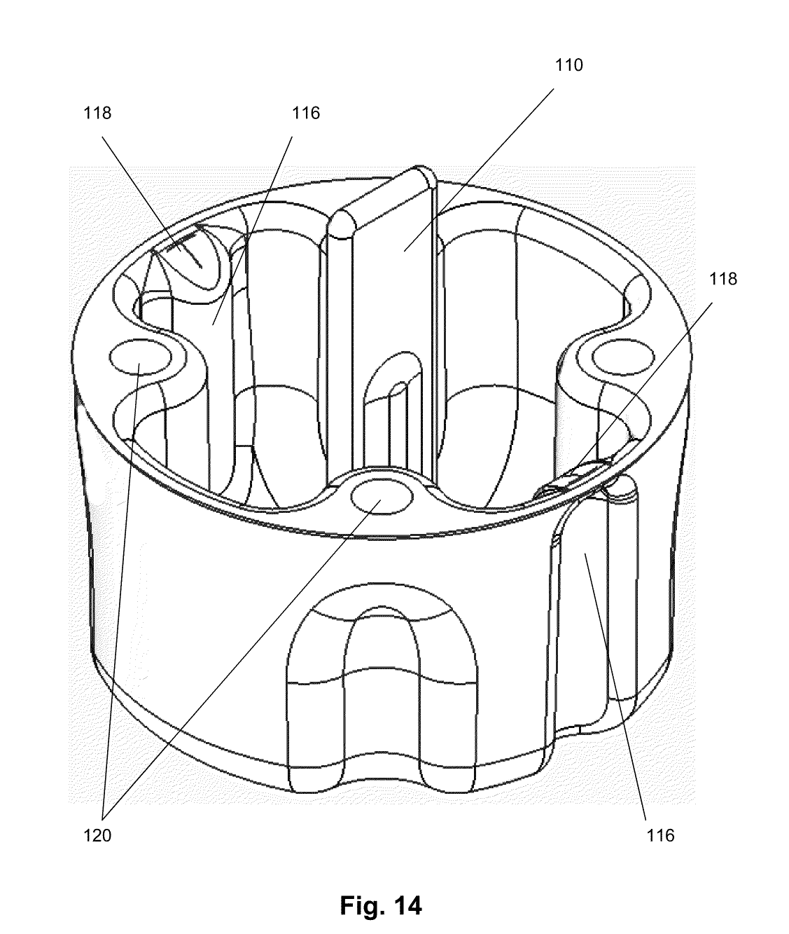

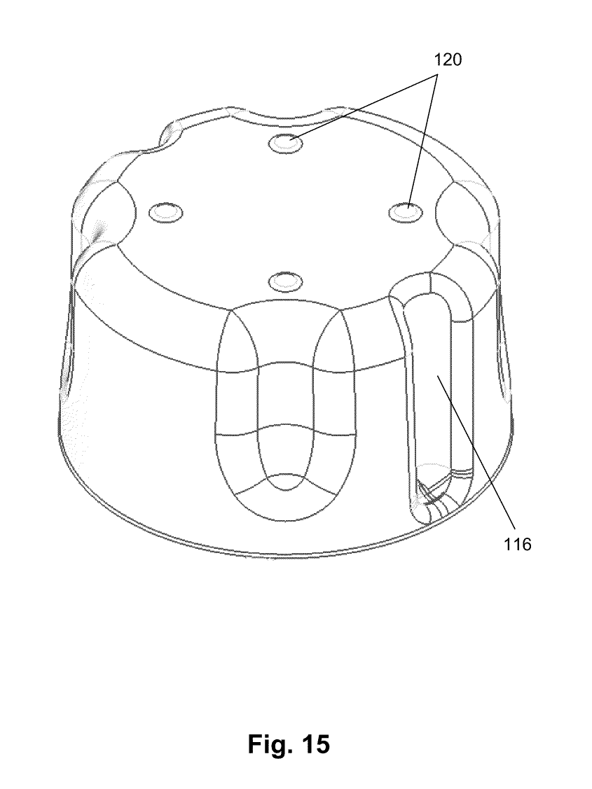

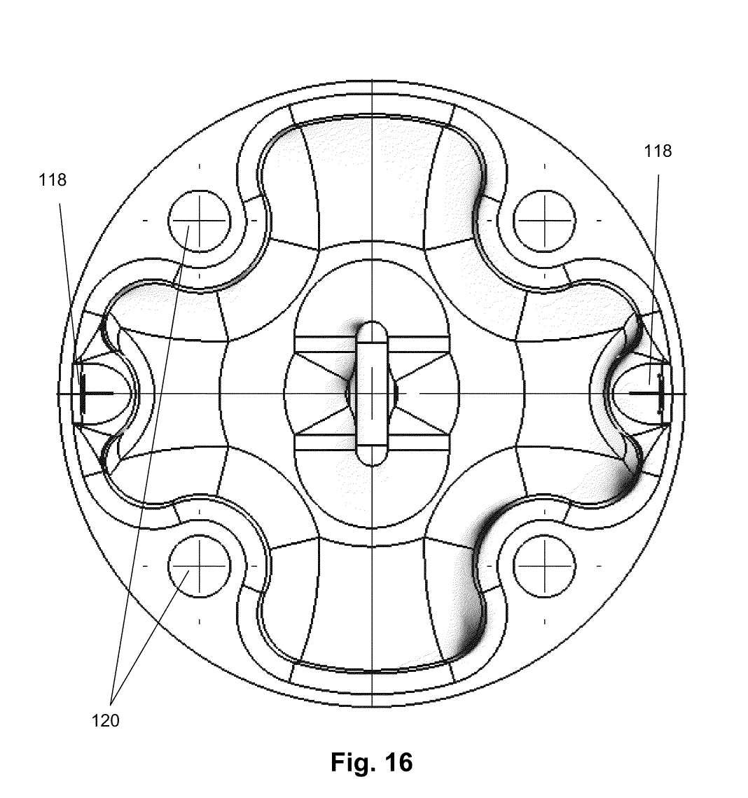

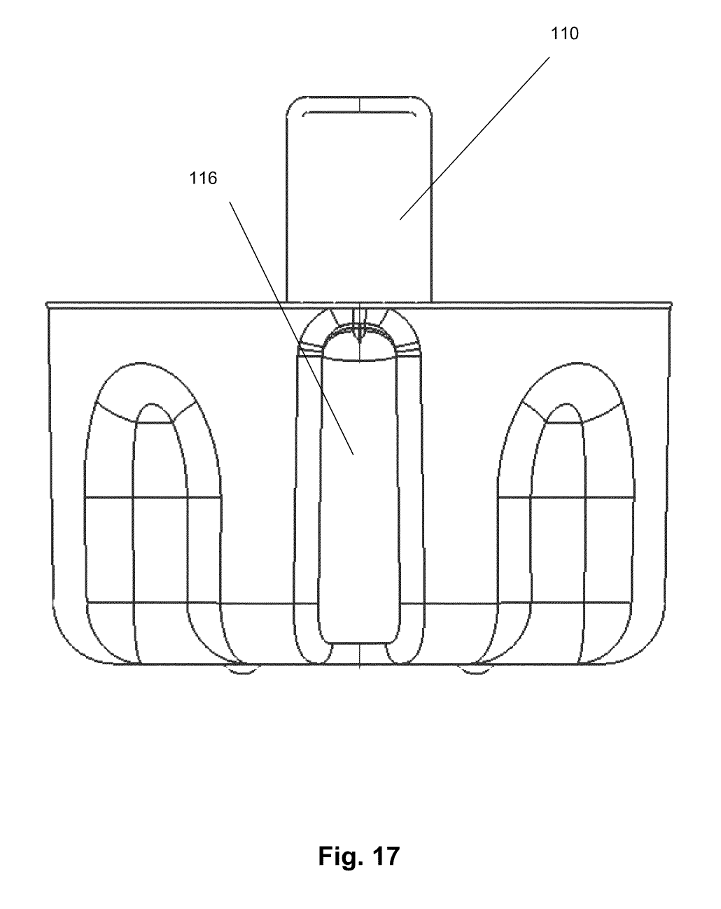

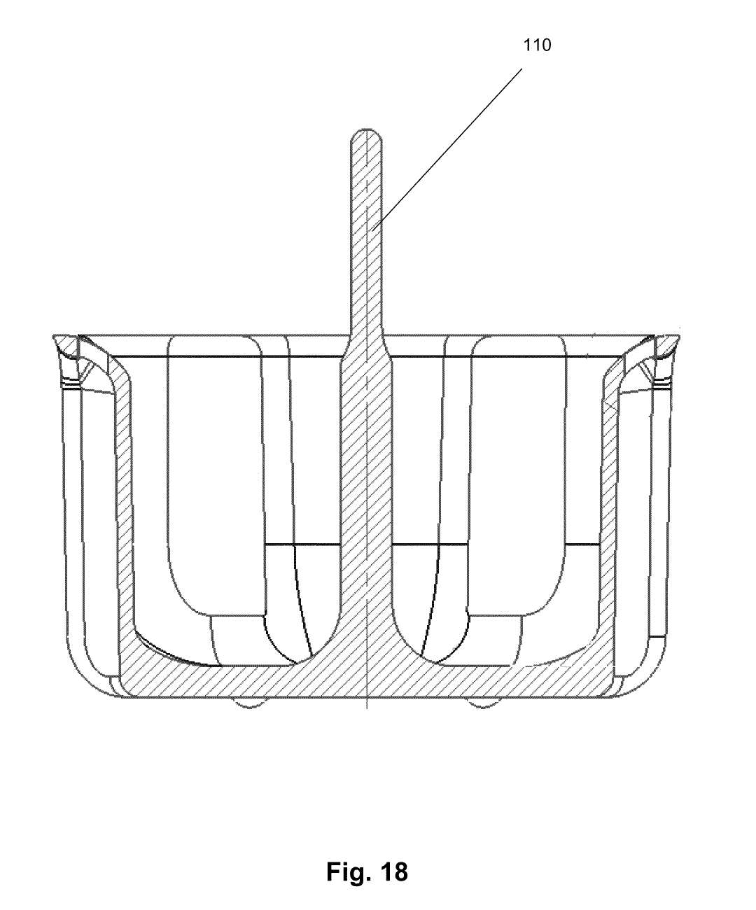

FIGS. 14-18 are various views of an alternative embodiment of an insert 100 according to the present invention. This embodiment is preferably more suited to commercial applications. Insert 100 preferably comprises center tab 110, which can be gripped between the thumb and index finger, which facilitates handling of insert 100, such as the accurate placement of the insert into the carafe and also manual removal in the event that magnets or other attaching elements 120 do not attach properly attach to the plunger/strainer. In the figures, tab 110 is shown as extending above the top rim of insert 100; because insert 100 is preferably comprised of a flexible material, such as silicone rubber, tab 110 is designed to collapse under the plunger, thereby enabling the plunger to contact magnets or other attaching elements 120 for removal of the insert. Tab 110 may alternatively extend up to or below the top rim of insert 100.

Insert 100 preferably comprises one or more vents or ports 116 disposed in insert 100 to prevent a vacuum from developing between the insert and the carafe as the insert is removed from the carafe. In this embodiment ports 116 are preferably disposed on the side walls of insert 100. Valve structure 118 disposed in port 116 preferably comprises one or more openings small enough to prevent the solids from settling into the ports, while being large enough to prevent formation of a vacuum during insert removal. For example, for an insert comprising a flexible material, valve structure 118 may comprise a plurality of flaps which remain substantially closed during brewing, but are forced apart from each another by the difference in pressure when the insert is removed from the carafe. In addition, insert 100 optionally comprises a textured bottom, for example comprising a plurality of protrusions 120, so the flat bottom of insert 100 doesn't rest directly on the flat bottom of the carafe, thus helping to prevent vacuum formation as the insert is removed from the carafe.

Unlike insert 10 of the previous embodiment, insert 100 preferably has a single compartment for holding, and preferably measuring a predetermined amount of the solids, and does not comprise an internal central area that is divided into measurement partitions, since for commercial applications it is assumed the same amount of coffee or other beverage is brewed for each batch. The amount of measured solids preferably corresponds to an amount required to brew a desired quantity of beverage. However, insert 100 may optionally comprise such partitions. In all embodiments, insert 100 is preferably invertible to facilitate removal of the spent solids, although this is not required.

Embodiments of the present invention described above are preferably intended as a new insert or retrofit for existing beverage brewing apparatus such as French press coffee makers. Another embodiment of the present invention preferably comprises a complete French press assembly with an integrated collection vessel or carafe specifically designed for that assembly. Said assembly preferably includes a carafe made of suitable material such as metal, glass, porcelain or other materials commonly used by those skilled in the art. The carafe may include a handle for manipulation of the carafe by hand and free of direct or tactile interface with the hot liquid contained therein. Also preferably included in the assembly are the lid with pouring spout accommodation, plunging rod with accommodation for a handle on one end and a straining assembly on the other, and a straining assembly. The straining assembly preferably comprises a perforated structural plate with an attached perimeter spring for securing a fine mesh straining material situated under the structural plate and against the inside wall of the carafe, thereby separating the coffee grounds in the lower portion of the carafe from the drinkable liquid above, and a lower perforated control plate for further stabilizing the straining mesh and structural plate, accommodating attachment to the plunging rod, and providing a platform for attachment to the collection vessel.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated herein by reference.

What is claimed is:

1. A removable insert for a brewing apparatus comprising a plunger assembly, the insert comprising:
one or more compartments for holding solids; and
one or more attachment devices for removeably attaching said insert to the plunger assembly;
wherein said insert is sized to slide within the apparatus.

2. The insert of claim 1 comprised of a flexible material.

3. The insert of claim 2 wherein said material comprises silicone rubber.

4. The insert of claim 2 invertible for emptying the solids from said compartments.

5. The insert of claim 1 further comprising one or more openings between a front surface of said insert and a rear surface of said insert.

6. The insert of claim 5 wherein each said opening comprises a valve structure which is sufficiently closed during brewing to prevent solids from entering said opening.

7. The insert of claim 6 wherein said valve structure opens sufficiently during removal of the insert from the apparatus to prevent a vacuum forming between said insert and the apparatus.

8. The insert of claim 7 wherein said valve structure comprises a plurality of flexible flaps.

9. The insert of claim 1 designed so that its rear surface does not rest flat against a bottom of the apparatus.

10. The insert of claim 1 wherein the brewing apparatus comprises a French press coffee maker.

11. The insert of claim 1 wherein said attachment devices are selected from the group consisting of magnets, magnetic bodies, magnetic fasteners, or mechanical clips.

12. The insert of claim 1 wherein said one or more compartments are sized to hold an amount of solids measured to produce a desired quantity of beverage.

13. The insert of claim 1 further comprising a squeegee blade disposed around a circumference of said insert.

14. The insert of claim 1 further comprising a protrusion for grabbing said insert.

15. The insert of claim 14 wherein said protrusion is located inside a circumference of said insert.

16. The insert of claim 1 wherein said insert comprises a solid bottom.

17. A method for brewing a beverage from solids, the method comprising the steps of:
disposing solids in one or more compartments in an insert;
inserting the insert in a brewing apparatus;
brewing the beverage;
straining solids from the beverage into the one or more;
attaching the insert to a plunger assembly;
withdrawing the plunger assembly from the apparatus;
removing the insert; and
emptying the solids from the one or more compartments.

18. The method of claim 17 wherein the removing step comprises grabbing a protrusion on the insert.

19. The method of claim 18 wherein the protrusion is located inside a circumference of the insert.

20. The method of claim 17 wherein the disposing step comprises measuring a desired amount of solids.

21. The method of claim 17 wherein the attaching step occurs automatically when the filter contacts the insert.

22. The method of claim 17 wherein the insert comprises a flexible material.

23. The method of claim 22 wherein the material comprises silicone rubber.

24. The method of claim 22 wherein the emptying step comprises inverting the insert.

25. The method of claim 17 wherein the apparatus comprises a French press coffee maker.

26. The method of claim 17 further comprising the step of opening holes in the insert sufficiently to prevent a vacuum forming between the insert and the apparatus during the removing step.
